(19) United States
(12) Patent Application Publication
(10) Pub. No.: US 2016/0177922 A1
(43) Pub. Date: Jun. 23, 2016

(54) TRAILING EDGE JETS ON WIND TURBINE BLADE FOR NOISE REDUCTION

(71) Applicant: Siemens Aktiengesellschaft, Muenchen (DE)

(72) Inventors: Alonso O. Zamora Rodriguez, Boulder, CO (US); Jennifer H. Frankland, Worthington, OH (US); John M. Obrecht, Louisville, CO (US)

(21) Appl. No.: 14/578,534

(22) Filed: Dec. 22, 2014

(51) Int. Cl. F03D 7/02; F03D 7/04; F03D 1/06

(52) U.S. Cl. CPC F03D 7/024; F03D 1/0675; F03D 7/0296; F03D 7/04

(57) ABSTRACT

One or more air nozzles (31) create respective air jets (34) angled radially from a blunt trailing edge (22) of a wind turbine blade (20A-G). The jets create and maintain a radially flowing airstream (36) along the trailing edge that extinguishes vortex shedding (28). This reduces drag and noise, thus allowing blades to have an extensive blunt trailing edge, which increases resistance to buckling, thus enabling longer blades. The jets may be supplied by airflow from an air intake in a blade chamber (44), or a ram air intake (40), or a compressor (54). Each nozzle may be individually metered (60) and/or individually or group valved (58) to provide a particular airflow to each nozzle relative to the other nozzles. Overall airflow to the nozzles may be modulated responsive to ambient conditions, and may be further cyclically modulated responsive to an azimuth of the blade

### FIELD OF THE INVENTION

This invention relates to reduction of noise and drag on wind turbine blades, and particularly to means for reducing noise and drag caused by vortex shedding behind blunt trailing edges.

### BACKGROUND OF THE INVENTION

Power of a wind turbine increases with blade length, which is constrained by material strength and airfoil geometry. A flatback airfoil has a flat or blunt trailing edge.

Herein, a flat or blunt trailing edge is a trailing edge with a flat or rounded thickness of at least 5% of the chord length. This provides increased buckling resistance over a sharp trailing edge, which enables a longer blade. However, a blunt trailing edge increases noise and drag due to vortex shedding, so such trailing edges have been limited to inboard portions of blades. FIG. 1 illustrates the geometry of a portion of a wind turbine blade 20 with a flat or blunt trailing edge 22 on a radially inboard portion of the blade, and a sharp trailing edge 24 on the remainder or outboard portion. Herein “radially” means generally oriented spanwise 21. Radially inward or inboard is toward the blade root. Radially outward or outboard is toward the blade tip. The flat or blunt portion 22 may be limited to approximately the radius of the blade shoulder 26, which is the position of greatest chord length. FIG. 2 shows vortex shedding 28 behind a flatback airfoil section with a leading edge LE and a chord line CL.

### BRIEF DESCRIPTION OF THE DRAWINGS

The invention is explained in the following description in view of the drawings that show:

FIG. 1 illustrates geometry of a portion of a prior art wind turbine blade with a blunt inboard trailing edge.

FIG. 2 is a transverse sectional view taken on line 2-2 of FIG. 1 showing vortex shedding behind the trailing edge.

FIG. 3 is a partial planform sectional view of a turbine blade with trailing edge jets in accordance with an aspect of the invention.

FIG. 4 is a transverse sectional view taken along line 4-4 of FIG. 3.

FIG. 5 is a perspective view of a portion of a wind turbine blade with flatback trailing edge nozzles.

FIG. 6 is a transverse sectional view of a flatback portion of a wind turbine blade with a ram air intake for the trailing edge jets.

FIG. 7 is a partial planform sectional view of a nozzle embodiment with a flow guide.

FIG. 8 is a partial planform sectional view of a nozzle formed by an air tube attached to and along the trailing edge.

FIG. 9 is a planform of a wind turbine blade with multiple trailing edge jets supplied by a compressor in the hub.

FIG. 10 is a planform of a wind turbine blade with multiple trailing edge jets supplied by compressors in the blade.

FIG. 11 is a planform of a wind turbine blade with multiple trailing edge jets supplied by ram air.

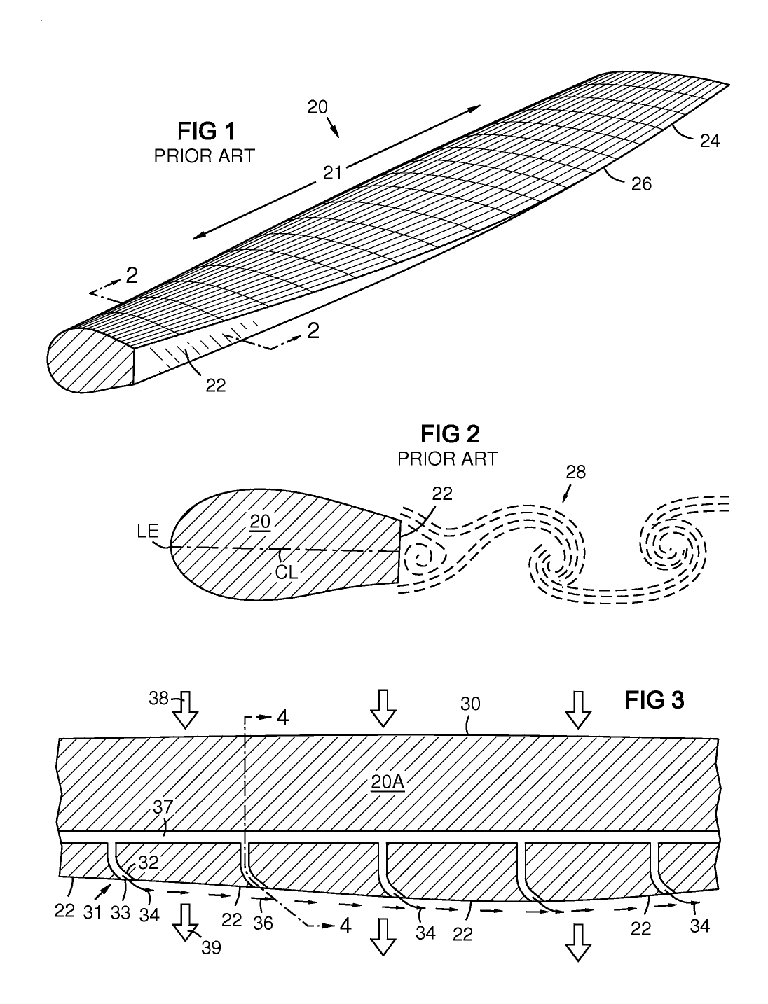

### DETAILED DESCRIPTION OF THE INVENTION

The inventors have discovered that flatback trailing edge vortex shedding can be reduced or extinguished by providing a radially flowing airstream just behind the flat trailing edge. This reduces noise and drag. Certain embodiments of the invention described more fully below generate and maintain such an airstream with air jets directed aft and radially outwardly or inwardly from the flat trailing edge.

FIG. 3 is a partial planform sectional view of a wind turbine blade 20A with a leading edge 30 and a blunt trailing edge 22. One or more nozzles 31 have a throat 32 with a mouth 33 on the trailing edge that directs an air jet 34 radially outwardly along the trailing edge. For example, the nozzles may be angled radially outwardly to within 50 degrees of parallel with the trailing edge 22 or within 40 or 30 degrees in some embodiments, although other angles are possible which result in a radially outwardly flowing airstream 36. The radially outwardly flowing airstream 36 adjacent to and behind the trailing edge mitigates trailing edge vortices. This causes the aerodynamic flow 38 to exit the trailing edge smoothly 39. The radial airstream 36 is sheltered by the flat trailing edge 22 and is further maintained by radial centrifugal pumping of the rotating blade. The jets 34 may be directed along a line or curve that is within or parallel to a plane of a local chordline of the blade, the plane being parallel to a span of the blade. Other embodiments (not illustrated) may utilize jets that establish a radially inward flow along the trailing edge.

Airflow for the jets 34 may be supplied from various sources, including, but not limited to, ambient air inside the blade, local compressors in the blade, a compressor in the nacelle or hub, or by one or more air intakes along the blade, including ram air intakes proximate the leading edge 30. Ambient atmospheric pressure is sufficient for the jets in some embodiments, since low pressure exists behind the trailing edge 22. Ambient air can be obtained from existing cavities in the blade that are equalized with ambient air. Alternately, an air supply channel 37 may have an ambient air intake near the root, and/or a ram air intake as later shown.

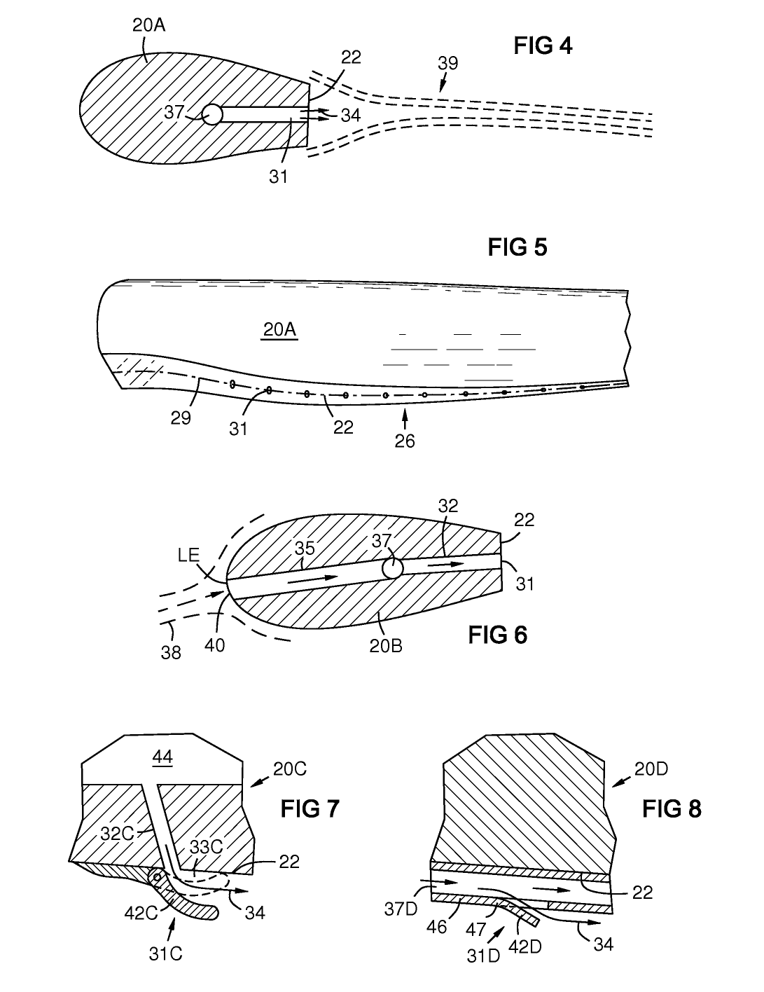

FIG. 4 is a transverse sectional view of the wind turbine blade 20A with a nozzle 31 in the flatback trailing edge 22 directing an air jet 34 that eliminates vortex shedding in the aerodynamic flow 39.

FIG. 5 is a perspective view of a portion of a wind turbine blade 20A with a row of nozzles 31 along a centerline 29 of the flatback trailing edge 22.

FIG. 6 is a transverse sectional view of a flatback portion of a wind turbine blade 20B with a ram air supply for the trailing edge jets 31. A ram air supply tube 35 has an intake 40 proximate the leading edge LE to provide ram air from the relative wind 38 at higher than ambient pressure. Each nozzle 31 may have such an intake 40, or one or more intakes 40 may be connected to an air supply channel 37, which supplies one or more nozzles.

FIG. 7 shows a nozzle 31C with a throat 32C, a mouth 33C, and a flow guide 42C, which is optionally movable to open and close the mouth. This figure and other illustrations of flow guides and nozzles herein are meant to be illustrative and not limiting, as other shapes, sizes and designs of devices for generating the trailing edge flow may be envisioned. The flow guide may guide the air jet 34 substantially parallel to the trailing edge. The nozzle throat 32C may be fabricated as a bore drilled straight into the trailing edge 22 to an inner chamber 44 of the turbine blade 20C. The flow guide may be unmovable, or optionally it may controllably pivot between open (solid) and closed (dashed) positions by means such as a galvanometer or stepper motor. It may be further controllable to intermediate positions. This allows the jet 34 to be modulated as needed depending on ambient conditions, and to be varied cyclically with blade azimuth to account for different conditions or requirements per rotor quadrant. In any embodiment with a flow guide herein, the term “nozzle” includes the flow guide.

FIG. 8 shows a nozzle 31 D with a flexible flow guide 42D formed as a flap of elastic material, for example nylon or polyester, that automatically opens and closes depending on air pressure differential between the air supply 37D and the aerodynamic slipstream adjacent to and behind the trailing edge 22 of the blade 20D. Such flexible guide may be mounted over a throat such as in FIG. 7. However, here it is shown as a partial cutout in an air tube 46 that is attached to and along the trailing edge 22. The partial cutout forms a flap 42D of the tube material with a hinge portion 47. The air tube 46 may be attached to and along the trailing edge with adhesive or with screws accessible through the flaps. Thus it may be retrofit to an existing blade. It provides an air supply channel 37D on and along the trailing edge. Radially outwardly angled nozzles 31D are provided in the aft wall of the air tube 46 to provide trailing edge jets 34. The source of air for the air supply channel 37D may be an open end near the blade root for ambient air. Alternately, or additionally, one or more ram air supply tubes may be attached to the pressure side of the blade between a leading edge ram air intake and the air tube 46.

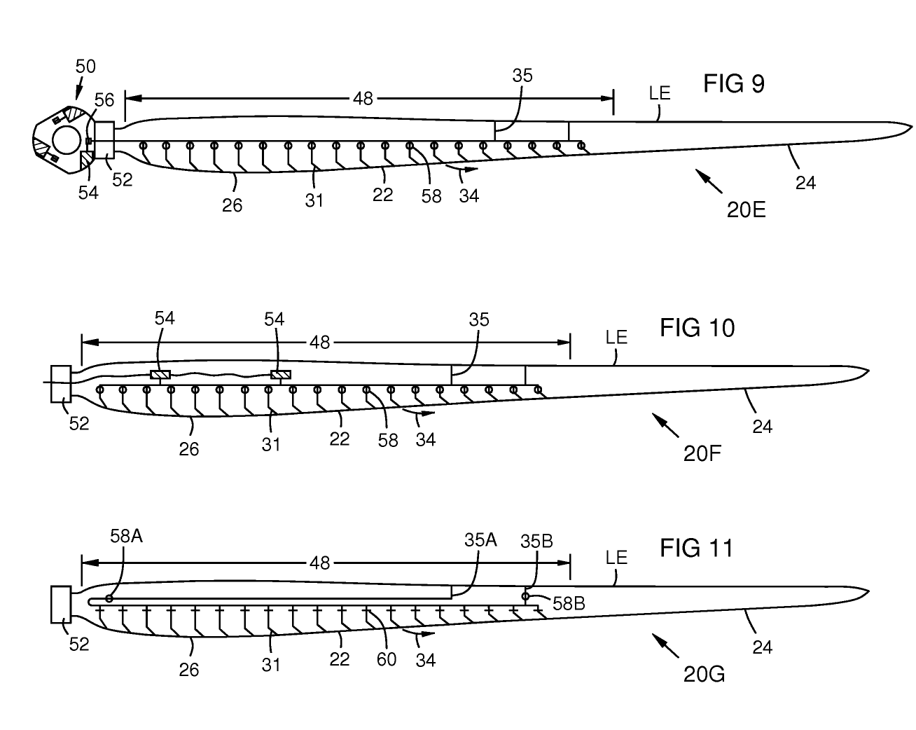

FIG. 9 is a planform of a wind turbine blade 20E with multiple trailing edge jet nozzles 31 supplied by a compressor 54 in the hub. The nozzles 31 may extend over an inboard portion 48 of the blade, such as 60% as shown, which portion may have a blunt trailing edge 22. The remaining outboard portion of the blade may have a sharp trailing edge 24. The blade is mounted to a hub 50 via a pitch control mechanism 52. The nozzles are fed by an air supply channel 37 connected to a compressor 54 in the hub via a rotary coupling 56. The compressor may be of any known type, such as piston, axial, centrifugal, etc. Alternately, the compressor 54 may be mounted in the wind turbine nacelle or in the blade. Alternately or additionally, the air supply channel may be fed by one or more ram air supply tubes 35 as previously shown. Optionally, some or all of the nozzles may be controlled by valves 58, either individually as shown, or in groups such as 5 nozzles per valve. This allows the air jets 34 to be controlled responsive to ambient conditions and to rapidly respond to changes, including the cyclic changes in blade azimuth.

FIG. 10 shows an embodiment of a wind turbine blade 20F with one or more compressors 54 mounted inside the blade instead of externally to it, thus avoiding the need for rotary couplings. This is just an example of possible configurations of compressors in the blade, ranging from one compressor 54 per nozzle 31 to one compressor serving all nozzles.

FIG. 11 shows a wind turbine blade 20G with a blunt trailing edge 22 over an inboard portion 48. A row of nozzles 31 is disposed along most or all of the blunt trailing edge 22. The nozzles are fed by an air supply channel 37, which is fed by one or more ram air supply tubes 35A-B. In this example, both the inboard and outboard ends of the air supply channel are supplied by a respective ram air supply tube 35A, 35B. The ram air intakes may be located outboard of the shoulder 26 or outboard of 30% span to obtain effective ram air pressure. Each supply tube 35A, 35B may be controllably valved 58A, 58B. Alternately, only one ram air supply tube 35A is needed for example if the inboard nozzles need more pressure to start the radial airstream than the succeeding nozzles need to maintain it. Each nozzle 31 may be individually metered 60, based on its radial position or proximity to the nearest supply tube and/or on other factors, to provide a particular jet pressure relative to the other nozzles. The ram air valves 58A, 58B adjust the overall absolute jet pressure responsive to ambient conditions and cyclic azimuth conditions. Alternately, each nozzle 31 may have an individually controllable valve as in FIG. 9.

The trailing edge jets herein reduce drag and noise penalties of a blunt trailing edge, allowing a blunt trailing edge to extend farther outward along the blade span. This extends the structural benefits of the flatback airfoil design without the penalties. For example, a wind turbine blade may use a flatback design on the inner 40% or 60% or 80% of the blade with high structural and aerodynamic efficiency.

While various embodiments of the present invention have been shown and described herein, it will be obvious that such embodiments are provided by way of example only. Numerous variations, changes and substitutions may be made without departing from the invention herein. While the figures herein illustrate several means for injecting a radially outflowing airstream behind a trailing edge of a wind turbine blade, other structures and systems may be envisioned to supply an airflow and to direct it radially along the trailing edge in order to mitigate vortex shedding behind the trailing edge during operation of the blade. Accordingly, it is intended that the invention be limited only by the spirit and scope of the appended claims.

The invention claimed is:

1. A wind turbine blade, comprising:
an airfoil shape extending radially and comprising a leading edge and a trailing edge;
an air nozzle on a trailing edge of the blade configured effective to create a radially flowing airstream adjacent to and behind the trailing edge when supplied with an airflow; and
a source of the airflow to the nozzle.

2. The wind turbine blade of claim 1, wherein the nozzle is angled radially outwardly to within 50 degrees of parallel to the trailing edge.

3. The wind turbine blade of claim 1, wherein the airflow is provided at ambient atmospheric pressure from a chamber or channel within the blade.

4. The wind turbine blade of claim 1, wherein the source of the airflow comprises a ram air intake proximate the leading edge of the blade.

5. The wind turbine blade of claim 1, wherein the nozzle comprises a throat with a mouth and a flow guide that curves over the throat from a radially inward side thereof, and directs the airstream outwardly substantially parallel with the trailing edge.

6. The wind turbine blade of claim 5, wherein the flow guide controllably pivots to variably open and close the mouth, and modulate the airstream in response to ambient conditions and in response to a blade azimuth.

7. The wind turbine blade of claim 1, further comprising additional nozzles conforming to claim 1 forming a row of nozzles along a flatback trailing edge portion of the blade, wherein the flatback trailing edge portion extends along greater than an inboard 40% of a span of the blade, and the row of nozzles extends along a majority of the flatback trailing edge.

8. The wind turbine blade of claim 7, further comprising an air tube attached to and along the trailing edge providing an air supply channel for the airflow, wherein the row of nozzles is formed as a row of elastic flaps in an aft wall of the air tube.

9. The wind turbine blade of claim 7, further comprising an air supply channel connected to the source of airflow and providing the airflow to a plurality of the nozzles, wherein each of the nozzles is individually metered to provide a predetermined airflow relative to the other nozzles.

10. The wind turbine blade of claim 9, further comprising a flow control valve on the air supply channel between the source of the airflow and the plurality of the nozzles, wherein the flow control valve controls the airflow to the nozzles responsive to ambient conditions and responsive to an azimuth of the blade.

11. The wind turbine blade of claim 7, further comprising an air supply channel connected to the source of airflow, and providing the airflow to a plurality of the nozzles via a respective control valve per nozzle, wherein the airflow in each of the nozzles is individually controlled to provide a particular airflow relative to the other nozzles and an absolute airflow responsive to ambient conditions.

12. The wind turbine blade of claim 7, further comprising an air supply channel that provides the airflow to the plurality of nozzles, wherein the air supply channel is connected to the source of the airflow, which comprises an ambient air intake of the air supply channel located proximate a root of the blade.

13. The wind turbine blade of claim 7, further comprising an air supply channel that provides the airflow to the plurality of nozzles, wherein the air supply channel is connected to the source of the airflow, which comprises an air compressor external to the blade.

14. The wind turbine blade of claim 7, further comprising an air supply channel that provides the airflow to the plurality of nozzles, wherein the air supply channel is connected to the source of the airflow, which comprises an air compressor in a hub to which the blade is attached.

15. The wind turbine blade of claim 7, further comprising an air supply channel that provides the airflow to the plurality of nozzles, wherein the air supply channel is connected to the source of the airflow, which comprises a ram air intake located proximate a leading edge of the blade.

16. A wind turbine blade characterized by a means for injecting a radially flowing airstream behind a trailing edge of the blade effective to mitigate vortex shedding from the trailing edge during operation of the blade with a wind turbine.

17. A wind turbine blade, comprising:
a blunt trailing edge disposed along at least a portion of a span of the blade;
a row of trailing edge jet nozzles on and along the blunt trailing edge;
each of the trailing edge jet nozzles producing a trailing edge jet that is angled radially to within 40 degrees of parallel with the blunt trailing edge; and
an air intake connected to the row of trailing edge jet nozzles, providing an airflow to the row of trailing edge nozzles, wherein the trailing edge jets create a radially flowing airstream adjacent to and behind the blunt trailing edge.

18. The wind turbine blade of claim 17, wherein at least some of the nozzles include a flow guide forming a mouth that opens in response to differential air pressure between the airflow to the nozzles and an aerodynamic slipstream adjacent to and behind of the blunt trailing edge.

19. The wind turbine blade of claim 17, wherein the air intake is a ram air intake proximate a leading edge of the blade and outboard of 30% of a span of the blade.

20. The wind turbine blade of claim 17, wherein each of the nozzles is individually metered or individually controllably valved to provide a particular relative airflow to each nozzle relative to the other nozzles, and the airflow to the row of nozzles is modulated responsive to ambient conditions and responsive to an azimuth of the blade.
